(19) United States
(12) Patent Application Publication
(10) Pub. No.: US 2010/0059683 A1
(43) Pub. Date: Mar. 11, 2010

(54) OPTIMIZING THE DESIGN OF A FLAT PANEL IMAGING DETECTOR UNIT

(76) Inventor: Marc Lauterbach, West Chester, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/205,469

(22) Filed: Sep. 5, 2008

(51) Int. Cl. G01T 1/20

(52) U.S. Cl. 250/363.02

(57) ABSTRACT

An apparatus including a scintillator panel including a first detector region having a first detecting quality to radiation occupying a first area of the scintillator panel and a second detector region having a second detecting quality to radiation different than the first detecting quality occupying a second area of the scintillator panel; and a light detector coupled to the scintillator panel to photoelectrically convert light generated by the scintillator panel.

### BACKGROUND

1. Field

The embodiments described below relate generally to imaging using radiation. More particularly, some embodiments concern a flat panel detector having non-uniform regions of detection.

2. Description

Images of internal patient volumes are commonly used in modern medical practice. Such images may be used to generate or confirm a diagnosis and/or to plan a course of treatment. In order to obtain an internal image, a patient is typically irradiated with a beam of radiation.

An integral part of diagnostic and therapeutic radiation imaging systems is a radiation detector that receives radiation modulated by the passage of the radiation through the body being examined or treated. The radiation detector may generally include a scintillator material that emits optical wavelength radiation when excited by the impinging radiation. In typical medical or industrial applications, the optical output from the scintillator material impinges upon an adjacent light or photo detector array that produces electrical output signals corresponding to the optical radiation received from the excited scintillator material. The amplitude of the output signals is generally related to the intensity of the impinging radiation. The electrical signals may be digitized and processed to generate, for example, absorption coefficients in a form suitable to display on an imaging screen or on a recording medium.

In some embodiments, radiation detectors may be uniform throughout a radiation detecting area. In order to generate high quality images, the entire extent of the radiation detector is constructed of suitable materials and devices to achieve high quality radiation imaging. In some aspects, the cost and technical challenges (size, weight, availability, etc.) of using a high quality radiation detector limits the feasibility and/or deployment of high quality radiation detectors that are uniform throughout the radiation detecting surface area.

### SUMMARY

To address at least the foregoing, some embodiments provide a system, method, apparatus, and means including a radiation image detector capable of producing a high quality radiation image in a specific region of the image detector. In some embodiments, an apparatus includes a scintillator panel including a first detector region having a first detecting quality to radiation occupying a first area of the scintillator panel and a second detector region having a second detecting quality to radiation different than the first detecting quality occupying a second area of the scintillator panel, and a light detector coupled to the scintillator panel to photoelectrically convert light generated by the scintillator panel.

In further aspects, the area of the second detector region is defined by a subsection of the area of the first detector region and has a peripheral boundary that may be shaped in the form of a rectangle, a square, or a circle. An apparatus and system herein may be capable of detecting various types of radiation, including at least one of kilovoltage, megavoltage, and gamma radiation.

In some aspects herein, the detecting quality of the second detector region to radiation is greater than that the detecting quality of the first detector region to the radiation.

In some aspects, a system may include a radiation source mounted on a gantry to emit radiation; and a flat panel detector located on the gantry spaced apart in relation to the radiation source at a location opposing the radiation source. The flat panel detector may include a scintillator panel including a first detector region having a first detecting quality to the radiation emitted by the radiation source and occupying a first area of the scintillator panel while a second detector region having a second detecting quality to the radiation emitted by the radiation source and occupies a second area of the radiation detection surface, where the second detecting quality to the radiation is different than the first detecting quality.

The claims are not limited to the disclosed embodiments, however, as those in the art can readily adapt the description herein to create other embodiments and applications.

### BRIEF DESCRIPTION OF THE DRAWINGS

The construction and usage of embodiments will become readily apparent from consideration of the following specification as illustrated in the accompanying drawings, in which like reference numerals designate like parts, and wherein:

FIG. 1 is a diagram illustrating aspects of a radiation imaging system, according to some embodiments herein;

FIG. 2 is a block diagram illustrating aspects of a flat panel detector, according to some embodiments;

FIG. 3 is an exemplary depiction of a flat panel detector, in accordance with some embodiments herein;

FIG. 4 is yet another depiction of a flat panel detector, in accordance with some embodiments herein; and

FIG. 5 is an exemplary depiction of an image generated, in accordance with some embodiments herein.

### DETAILED DESCRIPTION

The following description is provided to enable any person in the art to make and use the described embodiments and sets forth the best mode contemplated for carrying out some embodiments. Various modifications, however, will remain readily apparent to those in the art.

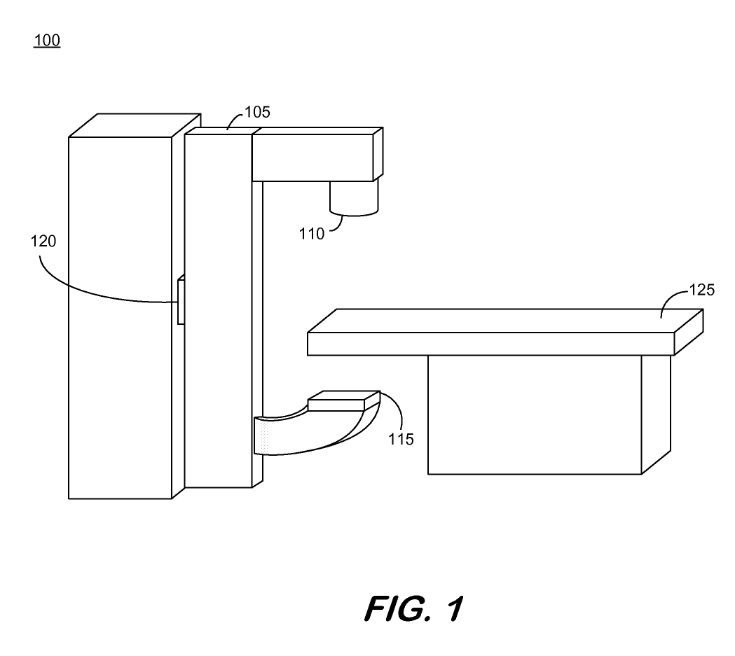

FIG. 1 illustrates a radiation imaging system 100 according to some embodiments. System 100 may be used in the context of medical radiography. System 100 includes a gantry 105 having a radiation source 110 and a radiation image detector 115 to detect radiation emitted from the radiation source. Radiation source 110 may comprise any suitable type of radiation. In some aspects, the radiation source may include, for example, megavolt, kilovolt (e.g., X-ray), or gamma radiation. A bed 125 is provided to position a subject, such as a human undergoing diagnostic imaging to a particular body part, in an area between radiation source 110 and radiation image detector 115. Gantry 105 may be rotated about a pivot point 120 in order to image a subject on bed 125 from a variety of angles to facilitate comprehensive imaging, including the acquisition of projection images used to generate three-dimensional images. Such rotation facilitates the acquisition of projection images used to generate three-dimensional (3-D) images.

In some embodiments, a computer system or processor (not shown) may be interfaced to or included with system 100 to control the operation of system 100. In some embodiments, a computer system or processor (not shown) may be interfaced to or included with system 100 to process images generated by system 100. System 100 may be operated to produce a 2-D image or further controlled to generate a 3-D image.

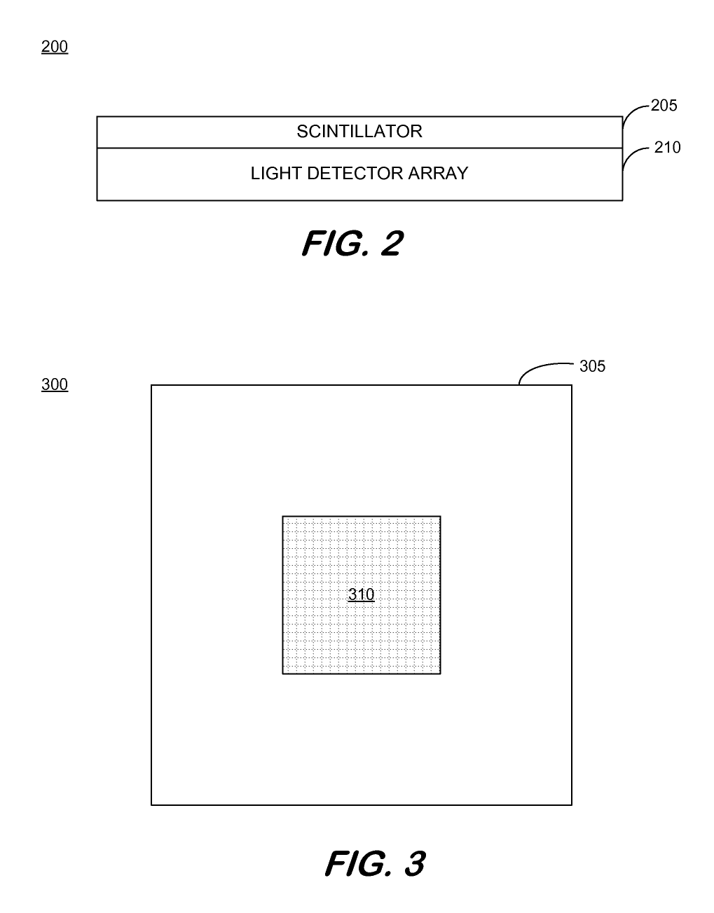

The particular radiation may depend on, for example, the goal of a medical or diagnostic session and the particular area of interest to be imaged and technical/practical considerations such as using the treatment beam of a Linear Accelerator for both imaging and treatment. FIG. 2 depicts a FPD 200 in accordance with embodiments herein. As shown, FPD 200 may include any suitable detector material, device, or system capable of detecting radiation from radiation source 110. In some embodiments, FPD 200 may include a scintillator 205 to convert radiation incident thereupon to visible light of a corresponding intensity. The light generated by scintillator 205 is subsequently converted to electrical signals in a detector array 210. The dimensions of projection images detected by FPD 200 are similar to the dimensions of the FPD including the detector array.

The dimensions of FPD 200 including scintillator 205 and detector array 210 are preferably sufficient to capture most of the radiation from the radiation source that passes through an object positioned on bed 125. In some embodiments, FPD 200 may be a square of about 40 cm×40 cm in size. A FPD sized as such is more than sufficient to facilitate imaging the cross-sectional area of many anatomical regions of interest.

Conventionally, the quality of the radiation detecting capabilities of FPDs is consistent and uniform across the entire radiation detecting extent of the FPD. FPDs capable of providing high quality images may employ newer and/or costlier radiation detecting materials and devices. However, as illustrated in the following Table 1, the area of interest may not necessitate the use of a high quality detecting and imaging material/devices over the entire radiation detecting extent of the FPD. As shown in FIG. 1, a number of anatomical areas and indicators used for patient setup corresponding to common tumor sites typically have dimensions smaller than a commonly sized square 40 cm×40 cm FPD.

TABLE 1

| | Tumor Site | | | |
|---|---|---|---|---|
| | | | Head & | |
| | Prostate | Lung | Neck | Brain |
| Anatomical | Prostate Gland, | Tumor | Tumor | Tumor |
| Area/ | Distance to | Lesion | Lesion | Lesion/ |
| Indicator | Bladder/Rectum | | | Skull |
| Used for | Wall | | | |
| Setup | | | | |
| Typical | (10-15) cm | (8-15) cm | (10-15) cm | (2-7) cm |
| Dimensions | | | | |
| of | | | | |
| Anatomical | | | | |
| Area | | | | |

FIG. 3 provides an exemplary illustration of a FPD 300, in accordance with some embodiments herein. As seen in the illustrated top view of FPD 300, the FPD includes a scintillator panel including a first detector region 305 and a second detector region 310. First detector region 305 occupies a first area of FPD 300 whereas second detector region 310 occupies a second area of the FPD. In some embodiments, first detector region 305 has a first detecting quality to radiation incident thereto and second detector region 310 has a second detecting quality to radiation incident thereto, where the first and second detecting qualities are different from each other. The quality of an image in different portions of the image generated using FPD 300 may vary and correspond to the detecting quality of the different detector regions of FPD 300.

As used herein, a “detecting quality” of a radiation detector device (e.g., FPD 300), scintillator (e.g. 205), and regions of the scintillator (e.g., 305, 310) refers to, for example, a sensitivity to radiation; an efficiency of the radiation detector; a contrast imaging capability of the radiation detector; a spatial resolution of the radiation detector; a contrast-to-noise factor, contributor, or attribute of the radiation detector; an angular selectivity of the radiation detector to radiation; and other factors, contributors, and attributes that, alone or in combination, influence the ability of the radiation detector to detect impinging radiation and provide an accurate representation of the impinging radiation. It will be appreciated by those skilled in the art that factors other than those specifically listed herein may also contribute to or detract from the radiation detecting capability of a radiation detector device or system. Accordingly, the factors, contributors, and attributes regarding a detecting quality are not limiting or exhaustive.

In some aspects, a radiation detector or detector region having a detecting quality higher than another detector region is capable of providing a higher quality image. The strength or value of the detecting quality of a radiation detector may be determined, measured, and/or calculated using a variety of processes, techniques, and protocols for grading the quality of an image or image processing device and system. Such processes, techniques, and protocols for grading the quality of an image or image processing device and system may be machine or processor based, manual based, or a combination manual and machine/processor based processes.

Accordingly, an FPD constructed and used in accordance with some embodiments herein, may facilitate the generation of images having different quality (e.g., image contrast, image detail, contrast-to-noise ration, angular sensitivity to incoming radiation, etc.) in different portions of the images.

In some embodiments, the outward peripheral boundary dimensions of first detector region 305 may measure about 40 cm×40 cm and second detector region 310 may be defined by a square shape having the outward peripheral boundary dimensions of about 15 cm×15 cm. Referring again to Table 1, it is noted that a 15 cm×15 cm square detector region is sufficient to cover a large portion, if not completely cover, a variety of anatomical areas of interest. In some embodiments where the imaging quality of the smaller second detector region is greater than the imaging capabilities of the larger first detector region, high quality images may be generated that capture images that encompass the area of interest. In some aspects, the cost, technical, and physical limitations due to some high quality detector materials and devices may be eliminated or at least lessened by confining the high quality detector materials and devices to less than a full extent of the radiation detecting device (e.g., FPD 300) while still achieving the acquisition of high quality images.

In some embodiments, the size and shape of the first and second detector regions may be optimally designed to limit the size of the higher quality detector region to a size sufficient for generating images suitable for the intended use and purpose of the FPD. In particular, the size and shape of the higher quality detector region may be optimally designed to correspond to or match the size and shape of an area of interest to be imaged.

In some aspects, FPD 300 may be employed with a system (e.g., 100) to generate 2-D images. In such embodiments, the generated images may have a center square image (due to attenuation) of higher quality than the surrounding image area. In some aspects, FPD 300 may be employed with a system (e.g., 100) to generate 3-D images. In such embodiments, the generated images may have a circular center volume of higher quality than the surrounding image area.

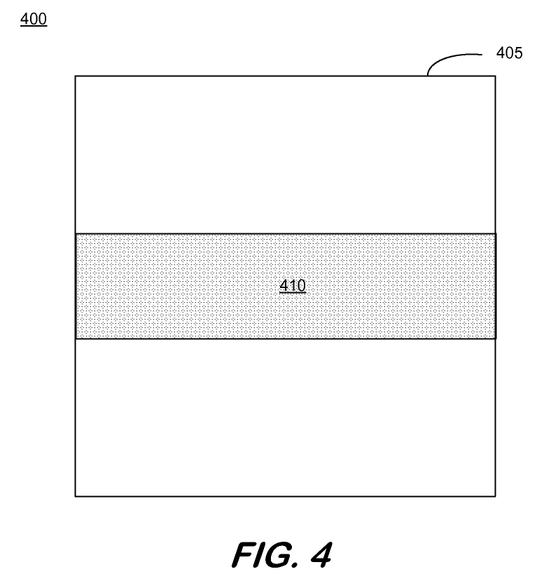

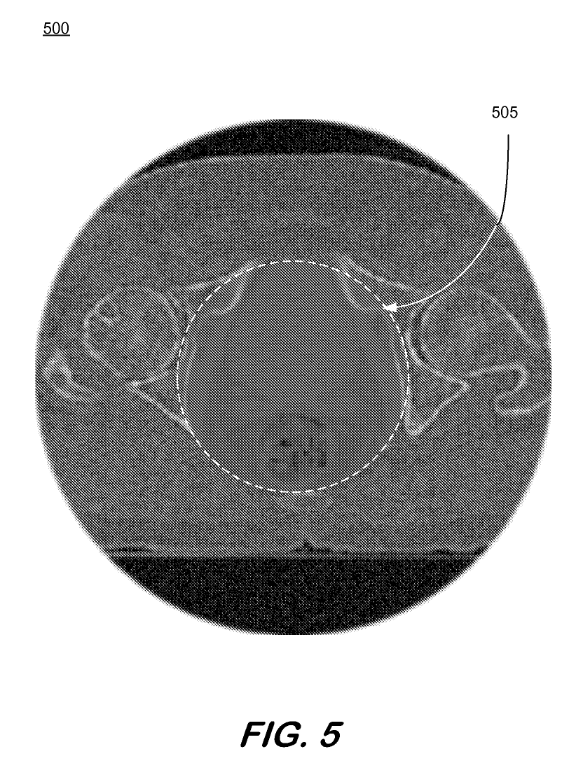

It should be appreciated that the size and shape of the first and second detector regions may be varied in accordance with optimally designed FPDs having more than one detector region, where the different detector regions have different image generating capabilities. FIG. 4 illustrates the top view of an exemplary FPD 400, including a scintillator panel including a first detector region 405 and a second detector region 410. First detector region 405 occupies a first area of FPD 400 and second detector region 410 occupies a second area of the FPD. In some embodiments, first detector region 405 and second detector region 410 have different detecting qualities to radiation that may be detected by FPD 400. The quality of an image in different portions of the image generated using FPD 400 may vary and correspond to the detecting quality of the different detector regions of FPD 400 to radiation.

As illustrated, the second detector region 410 includes a rectangular shaped stripe or strip of detector material(s) or device(s) extending from one side of FPD 400 to the opposing side of the FPD. As configured, FPD 400 may generate a stripe shaped higher quality image in an overall image generated by FPD 400. The higher quality image will correspond with second detector region 410.

In some embodiments, second detector region 410 may occupy a 10 cm×40 cm area whereas first detector region 405 has an outer peripheral boundary dimension of about 40 cm×40 cm. In some aspects, FPD 400 may be employed with a system (e.g., 100) to generate 2-D images. In such embodiments, the generated images will have a center rectangular-like image of higher quality than the surrounding image area. In some aspects, FPD 400 may be employed with a system (e.g., 100) to generate 3-D images. In such embodiments, the generated images will may a cylindrical center volume of higher quality than the surrounding image area. The following table, Table 2, includes a listing of the resulting image shapes/areas that may be generated using different shaped high quality/resolution radiation detectors.

TABLE 2

| | 2-D Radiograph | 3-D Cone Beam CT |
|---|---|---|
| The FPD of FIG. 3 | Square | Circle |
| The FPD of FIG. 4 | Stripe | Full Coverage |

As noted in Table 2, a 3-D image for a FPD similar to the one depicted in FIG. 4 yields a high quality image for all axial cross-sections coinciding with the high quality radiation detector 410.

It should be appreciated that the size, shape, orientation, and relative size and detecting qualities of the detector regions disclosed herein may vary, to best suit an application, subjects or area of interest being imaged, radiation source, desired or needed image quality, etc. In some embodiments, such as for example FIGS. 3 and 4, while the second detector region is shown as being a subsection of the first detector region and located substantially centered about a center location of the first detector region, this is not a requirement of the FPDs herein. Accordingly, the particular size, shape (square, rectangle, circle, triangle, and other customized shapes), orientation, and relative size and detecting quality of the detector regions of the present disclosure are not limited to the specific examples discussed herein.

FIG. 5 represents two-dimensional image 500 displayed according to some embodiments. Image 500 is a simulation of a resulting image based on the FPD of FIG. 3. The center circle 505 having a higher image quality than the remainder of the image is a result of the high quality image detector region located at the center of FPD 300. In the displayed example, the rounded edges of the center image is a result of a limited field of view of a 3-D cone beam image based on the full 40 cm×40 cm image detector region. In some embodiments, characteristics of images

What is claimed is:

1. An apparatus, the apparatus comprising:
a scintillator panel including a first detector region having a first detecting quality to radiation occupying a first area of the scintillator panel and a second detector region having a second detecting quality to radiation different than the first detector quality occupying a second area of the scintillator panel; and
a light detector coupled to the scintillator panel to photoelectrically convert light generated by the scintillator panel.

2. The apparatus of claim 1, wherein the second area is defined by a subsection of the first area.

3. The apparatus of claim 2, wherein the second area has a peripheral boundary shape selected from one of: a rectangle, a square, and a circle.

4. The apparatus of claim 1, wherein the scintillator panel is capable of detecting at least one of X-ray, megavoltage, and gamma radiation.

5. The apparatus of claim 1, wherein the first area of the first detector region is about 40 centimeters by about 40 centimeters and the second area of the second detector region is about 15 centimeters by about 15 centimeters.

6. The apparatus of claim 5, wherein the second area of the second detector region is about 10 centimeters by about 10 centimeters.

7. The apparatus of claim 1, wherein the second detector region is centered about a central location of the first detector region.

8. The apparatus of claim 1, wherein the detecting quality of the second detector region to a first type of radiation is greater than that the detecting quality of the first detector region to the first type of radiation.

9. The apparatus of claim 1, wherein the light detector comprises an array of pixel elements.

10. The apparatus of claim 1, further comprising a radiation source to emit radiation and located on a gantry opposing the scintillator panel and light detector.

11. A system comprising:
a radiation source mounted on a gantry to emit radiation; and
a flat panel detector located on the gantry at a distance spaced apart from and opposing the radiation source, the flat panel detector comprising:
a scintillator panel including a first detector region having a first detecting quality to the radiation emitted by the radiation source occupying a first area of the scintillator panel and a second detector region having a second detecting quality to the radiation emitted by the radiation source occupying a second area of the scintillator panel, the second detecting quality being different than the first detecting quality; and
a light detector coupled to the scintillator panel to photoelectrically convert light generated by the scintillator panel.

12. The system of claim 11, wherein the second area is defined by a subsection of the first area.

13. The system of claim 11, wherein the second area has a peripheral boundary shape selected from one of: a rectangle, a square, and a circle.

14. The system of claim 11, wherein the scintillator panel is capable of detecting at least one of X-ray, megavoltage, and gamma radiation.

15. The system of claim 11, wherein the first area of the first detector region is about 40 centimeters by about 40 centimeters and the second area of the second detector region is about 15 centimeters by about 15 centimeters.

16. The system of claim 15, wherein the second area of the second detector region is about 10 centimeters by about 10 centimeters.

17. The system of claim 11, wherein the second area of the second detector region is centered about a central location of the first area of the first detector region.

18. The system of claim 11, wherein the detecting quality of the second detector to the radiation emitted by the radiation source is greater than the detecting quality of the first detector region to the radiation emitted by the radiation source.

19. The system of claim 11, wherein the light detector comprises an array of pixel elements.

20. The system of claim 11, wherein the flat panel detector is selectively positioned to orientate the first and second detector regions to produce an image having a pre-determined shape inside of a larger image when a subject located between the radiation source and the flat panel detector is irradiated by the radiation and the gantry is rotated about the subject.
generated by FPDs herein, such as contrast, gray level, brightness, etc. may be manipulated by image processing devices, systems, and processes.
Process steps may be embodied, in whole or in part, by hardware of and/or software executed by elements including but not limited to those of an imaging system (e.g., system 100) and computer system (not shown) to facilitate and provide radiation imaging using the FPDs disclosed herein. Software embodying process steps, code, program instructions, or the like may be stored by any tangible medium residing anywhere in system 100, including a fixed disk, a floppy disk, a CD-ROM, a DVD-ROM, a memory, or a magnetic tape. Some or all of such software may also be stored in one or more devices.
Those in the art will appreciate that various adaptations and modifications of the above-described embodiments can be configured without departing from the scope and spirit of the claims. Therefore, it is to be understood that the claims may be practiced other than as specifically described herein.
